(19) United States
(12) Patent Application Publication
(10) Pub. No.: US 2012/0231807 A1
(43) Pub. Date: Sep. 13, 2012

(54) FREQUENCY AND TIMING CONTROL FOR FEMTOCELL

(75) Inventors: Seung-Hyun Kong, San Diego, CA (US); Wenhui Xiong, San Diego, CA (US)

(73) Assignee: QUALCOMM INCORPORATED, San Diego, CA (US)

(21) Appl. No.: 13/045,825

(22) Filed: Mar. 11, 2011

(51) Int. Cl. H04W 24/00; H04W 92/00

(52) U.S. Cl. 455/456.1; 455/422.1

(57) ABSTRACT

Techniques are provided for frequency and/or timing synchronization of a small base station with a network. In one example, small base station may be configured to detect a macro signal of a macro base station, and set a frequency reference based at least in part on the macro signal, in response to the macro signal being available in a different band than that for the small base station. The small base station may be configured to set the frequency reference based at least in part on a Global Positioning System (GPS) signal, in response to detecting that the different band macro signal is not available.

### BACKGROUND

1. Field

The present application relates generally to wireless communications, and more specifically to methods and systems for frequency and time synchronization of a femtocell with a wireless network.

2. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of network entities, such as base stations, that can support communication for a number of mobile entities/devices, such as, for example, access terminals (ATs) or user equipments (UEs). A mobile entity may communicate with a base station via a downlink and uplink. The downlink (or forward link) refers to the communication link from the base station to the AT, and the uplink (or reverse link) refers to the communication link from the AT to the base station.

The 3rd Generation Partnership Project (3GPP) Long Term Evolution (LTE) represents a major advance in cellular technology as an evolution of Global System for Mobile communications (GSM) and Universal Mobile Telecommunications System (UMTS). The LTE physical layer (PHY) provides a highly efficient way to convey both data and control information between base stations, such as an evolved NodeBs (eNBs), and mobile entities, such as UEs. In addition, a new class of small base stations has emerged, which may be installed in a user's home and provide indoor wireless coverage to mobile units using existing broadband Internet connections. Such a base station is known as a femto Base Station (fBS), but may also be referred to as a femtocell, a Home NodeB (HNB) unit, Home evolved NodeB unit (HeNB), femto access point, or base station transceiver system. Typically, the femtocell is coupled to the Internet and the mobile operator's network via a Digital Subscriber Line (DSL), cable internet access, T1/T3, or the like, and offers typical base station functionality, such as Base Transceiver Station (BTS) technology, radio network controller, and gateway support node services. This allows an cellular/mobile device or handset (e.g., AT or UE), to communicate with the femtocell and utilize the wireless service.

With the deployment of femtocells in numerous environments, often times in indoor locations with limited or no macro signals from macro base stations and/or weak Global Positioning System (GPS) signal strength, there is a growing need to facilitate frequency and/or timing synchronization of femtocells with a wireless communication network. In a synchronous network, for example, it would be desirable to detect and prioritize the use of the available reference signals to tune a clock generator of the femtocell, and thereby achieve frequency and timing control for the femtocell.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with methods for synchronization with a network by a small base station. The method may involve detecting a macro signal of a macro base station. The method may involve setting a frequency reference based at least in part on the macro signal, in response to the macro signal being available in a different band than that for the small base station.

In related aspects, the method may further involve setting the frequency reference based at least in part on a Global Positioning System (GPS) signal, in response to detecting that the different band macro signal is not available. The method may further involve setting the frequency reference based at least in part on a same band macro signal, in response to detecting that the different band macro signal and the GPS signal are not available. In further related aspects, the method may further involve setting a timing reference based at least in part on the different band macro signal, in response to the network comprising a synchronous network. In yet further related aspects, an electronic device may be configured to execute the above described methodology.

In accordance with one or more embodiments and corresponding disclosure thereof, various aspects are described in connection with a small base station synchronization method. In one embodiment, the method may involve determining a signal strength of a GPS signal. The method may involve setting the frequency reference based at least in part on the GPS signal, in response to the GPS signal strength meeting a defined minimum strength.

In related aspects, the method may further involve setting the frequency reference based at least in part on a different band macro signal, in response to the GPS signal strength failing to meet the defined minimum strength. The method may further involve setting the frequency reference based at least in part on a same band macro signal, in response to detecting that the different band macro signal and the GPS signal are not available. In further related aspects, the method may further involve setting a timing reference based at least in part on the GPS signal, in response to the network comprising a synchronous network. In yet further related aspects, an electronic device may be configured to execute the above described methodology.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 illustrates a multiple access wireless communication system.

FIG. 2 illustrates a block diagram of a communication system.

FIG. 3 illustrates an exemplary wireless communication system.

FIG. 4 illustrates an exemplary communication system to enable deployment of access point base stations within a network environment.

FIG. 5 shows an exemplary method for femtocell time and frequency control.

FIG. 6 shows an exemplary method for femtocell reference selection in a synchronous network.

FIG. 7 shows another exemplary method for femtocell reference selection in a synchronous network.

FIG. 8 shows an exemplary method for femtocell reference selection in an asynchronous network.

FIG. 9 shows another exemplary method for femtocell reference selection in an asynchronous network.

FIG. 10 provides a table with exemplary settling times for disciplining a clock generator.

FIG. 11 shows an exemplary method for frequency control when a femtocell uses a same band macro signal for feedback control of a clock generator.

FIG. 12 shows an exemplary method for timing control for continuous tracking mode.

FIG. 13 illustrates an exemplary method for estimating the average path positions for timing reference generation for continuous tracing mode.

FIG. 14 illustrates an exemplary method for updating timing reference estimations.

FIG. 15 illustrates an exemplary method for estimating the average path positions for discontinuous transmission mode.

FIG. 16 illustrates an embodiment of a methodology for frequency and/or timing control for a small base station of a femtocell.

FIGS. 17-18 illustrate further aspects of the embodiment of FIG. 16.

FIG. 19 illustrates another embodiment of a methodology for frequency and/or timing control for a small base station of a femtocell.

FIGS. 20-21 illustrate further aspects of the embodiment of FIG. 19.

FIG. 22 shows an embodiment of an apparatus for frequency and/or timing synchronization.

FIG. 23 shows another embodiment of an apparatus for frequency and/or timing synchronization.

### DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) can be practiced without these specific details. In other instances, well-known structures and devices are shown in block diagram form in order to facilitate describing one or more embodiments. The word “exemplary” is used herein to mean “serving as an example, instance, or illustration.” Any embodiment described herein as “exemplary” is not necessarily to be construed as preferred or advantageous over other embodiments.

The techniques described herein may be used for various wireless communication networks such as CDMA, TDMA, FDMA, OFDMA, SC-FDMA and other wireless networks. The terms “network” and “system” are often used interchangeably. A CDMA network may implement a radio technology such as Universal Terrestrial Radio Access (UTRA), cdma2000, etc. UTRA includes Wideband CDMA (WCDMA), Time Division Synchronous CDMA (TD-SCDMA), and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A), in both FDD and TDD, are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies.

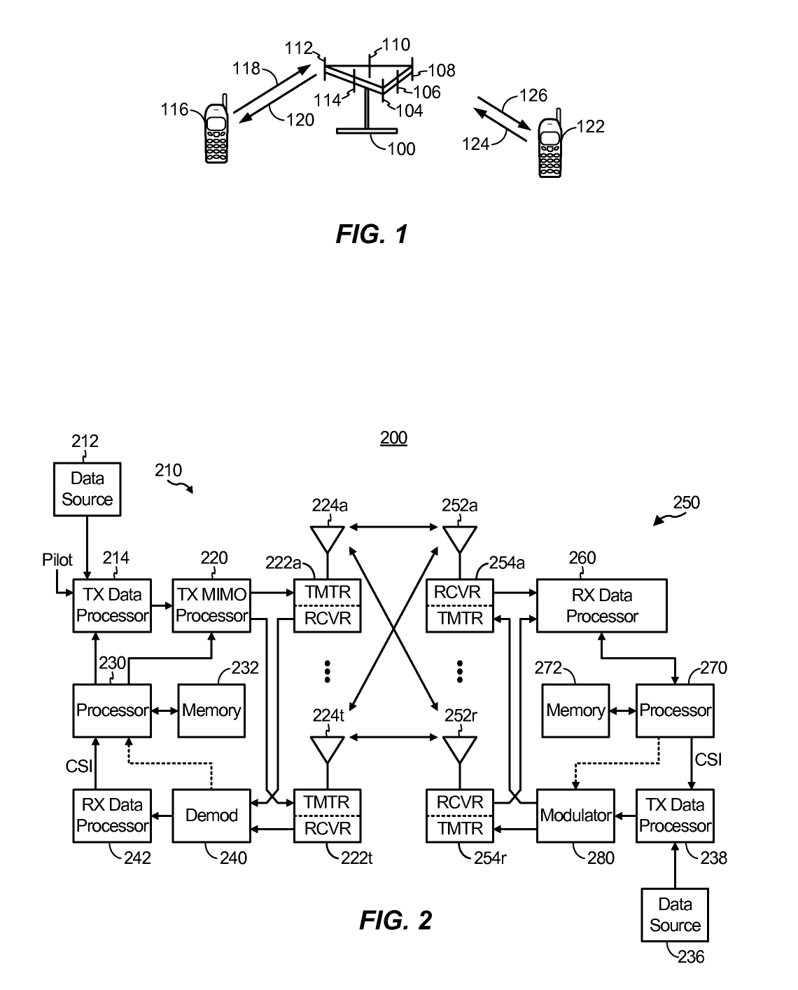

Referring to FIG. 1, a multiple access wireless communication system according to one embodiment is illustrated. An access point 100 (e.g., base station, evolved NodeB (eNB), or the like) includes multiple antenna groups, one including 104 and 106, another including 108 and 110, and an additional including 112 and 114. In FIG. 1, two antennas are shown for each antenna group, however, more or fewer antennas may be utilized for each antenna group. A access terminal 116 (AT) is in communication with the antennas 112 and 114, where the antennas 112 and 114 transmit information to the AT 116 over a forward link 120 and receive information from the AT 116 over a reverse link 118. An AT 122 is in communication with the antennas 106 and 108, where the antennas 106 and 108 transmit information to the AT 122 over a forward link 126 and receive information from the AT 122 over a reverse link 124. In a FDD system, the communication links 118, 120, 124 and 126 may use different frequency for communication. For example, the forward link 120 may use a different frequency then that used by the reverse link 118.

Each group of antennas and/or the area in which they are designed to communicate is often referred to as a sector of the access point. In the embodiment, antenna groups each are designed to communicate to ATs in a sector, of the areas covered by the access point 100.

In communication over the forward links 120 and 126, the transmitting antennas of the access point 100 utilize beamforming in order to improve the signal-to-noise ratio of forward links for the different ATs 116 and 124. Also, an access point using beamforming to transmit to ATs scattered randomly through its coverage causes less interference to ATs in neighboring cells than an access point transmitting through a single antenna to all its ATs.

It is noted that an access point may be a fixed station used for communicating with the terminals and may also be referred to herein as a base station, a NodeB, an eNB (e.g., in the context of an LTE network), or the like. An AT may also be referred to herein as a mobile entity, a user equipment (UE), a wireless communication device, terminal, or the like.

FIG. 2 is a block diagram of an embodiment of a transmitter system 210 (i.e., an access point) and a receiver system 250 (i.e., an AT) in a MIMO system 200. At the transmitter system 210, traffic data for a number of data streams is provided from a data source 212 to a transmit (TX) data processor 214.

In an embodiment, each data stream is transmitted over a respective transmit antenna. The TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., Binary Phase Shift Keying (BPSK), Quadrature Phase Shift Keying (QSPK), M-ary Phase-Shift Keying (M-PSK), or Multi-Level Quadrature Amplitude Modulation (M-QAM)) selected for that data stream to provide modulation symbols. The data rate, coding, and modulation for each data stream may be determined by instructions performed by a processor 230, which may be in operative communication with a memory 232.

The modulation symbols for the data streams are then provided to a TX MIMO processor 220, which may further process the modulation symbols (e.g., for OFDM). The TX MIMO processor 220 then provides N_{T} modulation symbol streams to N_{T} transmitters (TMTR) 222a through 222t. In certain embodiments, the TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At the receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from the N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by the RX data processor 260 is complementary to that performed by the TX MIMO processor 220 and the TX data processor 214 at the transmitter system 210.

A processor 270 periodically determines which pre-coding matrix to use, discussed further below. The processor 270 formulates a reverse link message comprising a matrix index portion and a rank value portion, and may be in operative communication with a memory 272.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to the transmitter system 210.

At the transmitter system 210, the modulated signals from the receiver system 250 are received by the antennas 224, conditioned by the receivers 222, demodulated by a demodulator 240, and processed by a RX data processor 242 to extract the reserve link message transmitted by the receiver system 250. The processor 230 then determines which pre-coding matrix to use for determining the beamforming weights then processes the extracted message.

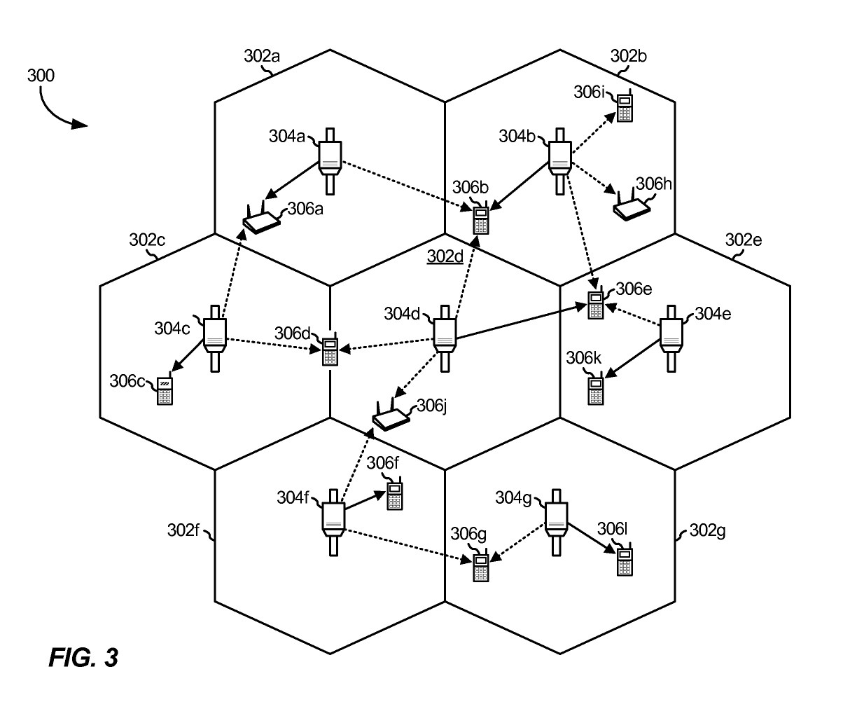

FIG. 3 illustrates an exemplary wireless communication system 300 configured to support a number of users, in which various disclosed embodiments and aspects may be implemented. As shown in FIG. 3, by way of example, the system 300 provides communication for multiple cells 302, such as, for example, macrocells 302a-302g, with each cell being serviced by a corresponding access point 304 (such as access points 304a-304g). Each cell may be further divided into one or more sectors. Various ATs 306, including ATs 306a-306k, may be dispersed throughout the system. Each AT 306 may communicate with one or more access points 304 on a forward link and/or a reverse link at a given moment, depending upon whether the AT is active and whether it is in soft handoff, for example. The wireless communication system 300 may provide service over a large geographic region, for example, the macrocells 302a-302g may cover a few blocks in a neighborhood.

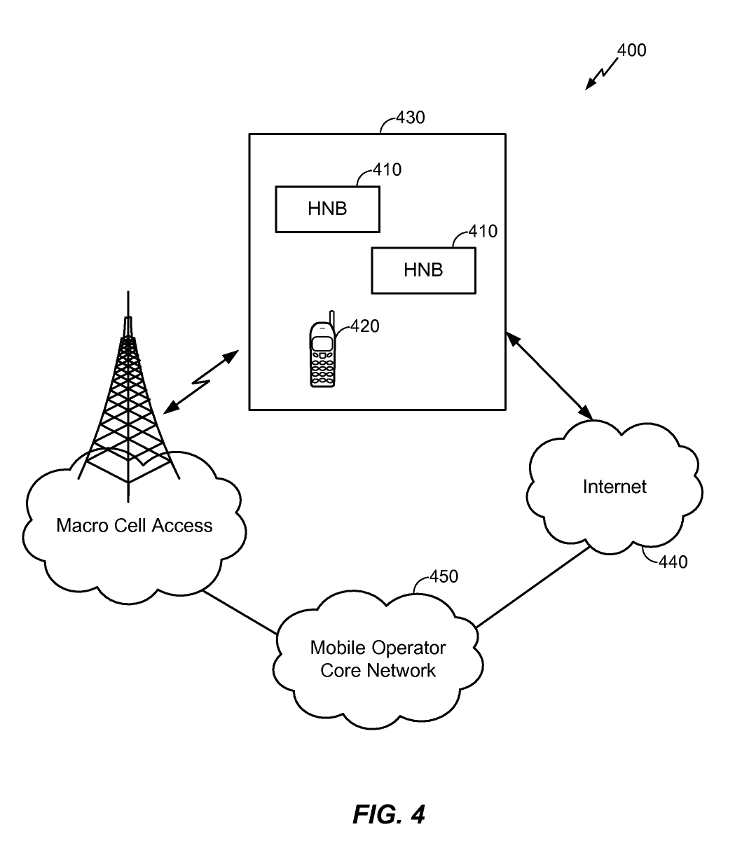

FIG. 4 illustrates an exemplary communication system 400 to enable deployment of access point base stations within a network environment. As shown in FIG. 4, the system 400 includes multiple access point base stations or Home NodeB units (HNBs) or femto access points, such as, for example, HNBs 410, each being installed in a corresponding small scale network environment, such as, for example, in one or more user residences 430, and being configured to serve an associated, as well as alien, AT 420. Each HNB 410 is further coupled to the Internet 440 and a mobile operator core network 450 via a DSL router (not shown) or, alternatively, a cable modem (not shown).

In related aspects, the owner of the HNB 410 may subscribe to mobile service, such as, for example, 3G mobile service, offered through the mobile operator core network 450, and the AT 420 may be capable of operating both in a macro-cellular environment and a residential small scale network environment. Thus, the HNB 410 may be backward compatible with any existing AT 420.

In further related aspects, in addition to the macrocell mobile network 450, the AT 420 can be served by a given number of HNBs 410, namely the HNBs 410 that reside within the user's residence 430, and cannot be in a soft handover state with the macro network 450. The AT 420 can communicate either with the macro network 450 or the HNBs 410, but not both simultaneously. As long as the AT 420 is authorized to communicate with the HNB 410, within the user's residence it is preferable that the AT 420 communicate with the associated HNBs 410.

In accordance with aspects of the particular subject of this disclosure, there are provided methods and apparatuses for frequency and timing synchronization of a femtocell with a wireless communication network. An inherent challenge in achieving such synchronization is that femtocells are typically deployed indoors, and sometimes in environments where Global Positioning System (GPS) signals and/or macro signals are weak or not available at all.

It is desirable for femtocells to have accurate time synchronization with the wireless network, as well as accurate frequency reference information for the generation of radio frequency carrier(s) and sampling clocks. The frequency and time synchronization of the femtocell can be obtained by using a GPS receiver unit within the femtocell. However, the GPS signal may not be available in certain environments, such as, for example, deep indoors or in a basement. In a scenario where the GPS signal is not available, the femtocell should utilize the available macro signal to achieve frequency and/or time synchronization.

The timing functionality of modem chipsets used in femtocells, such as, for example, CDMA and UMTS modem chipsets, such as, for example, Mobile Station Modem (MSM), which derives the timing reference for the modem, provides a candidate solution for femtocell timing control using available macro signals. However, the timing derived from the timing functionality is based on the earliest arrival finger, which has a propagation delay between the base station and the receiver. The propagation delay should to be properly calibrated to satisfy the femtocell's time synchronization requirement (e.g., 3-10 μsec with respect to the GPS time). In addition, since the reference timing update is based on the earliest finger among the fingers that are in lock and tracking the pilot signals from the base stations, timing reference jitter may be present when the earliest finger position changes abruptly due to fading. For example, the femtocell modem may update its timing reference every 160 ms. Specifically, every 160 msec, the modem slews its clock by ⅛ of a chip towards the earliest finger (i.e., the modem timing slew rate is ⅛ of a chip every 160 ms.).

The frequency control of the femtocell using the macro signal may be achieved using an Automatic Frequency Control (AFC) design or the like, modified for the specific operation of femtocells. Specifically, when the femtocell is operating at the same band as the macro, it should shut down its transmission when it listens to the macro signal. Therefore, the frequency control method of the femtocell, when using the macro signal, should be short and less frequent in order to avoid interrupting the femtocell transmission. Described in further detail below are the timing and frequency control schemes that may be implemented in the femtocell when the macro signal is used as the primary reference signal.

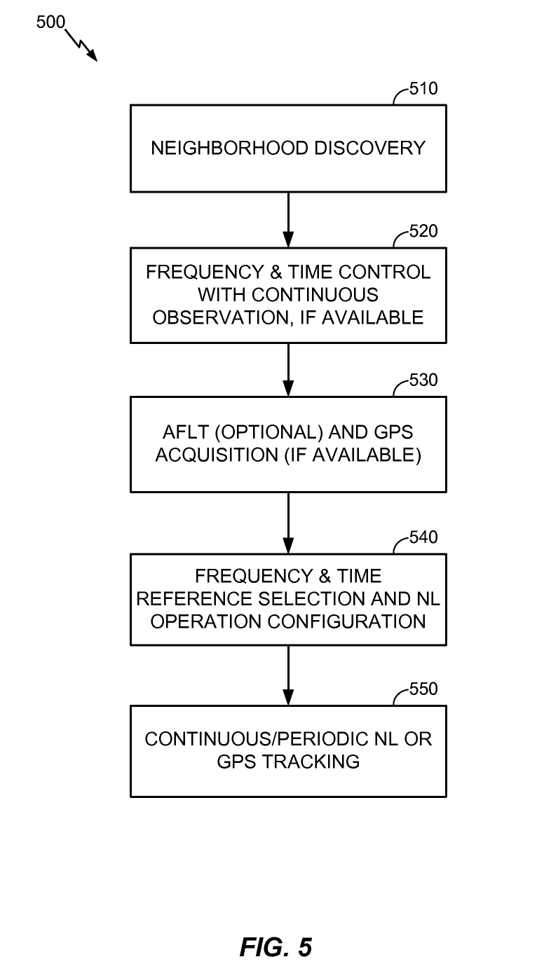

With reference to FIG. 5, there is provided an exemplary flow diagram for time/frequency control, which shows the overall network listen procedure related to timing and/or frequency control. At 510, the femtocell may perform neighborhood discovery to discover the macro and/or femto signal. At 520, in response to finding an available signal, macro or femto, for timing and/or frequency control, the femtocell may begin tuning and stabilizing its clock generator, such as, for example, a Crystal Oscillator (XO) or the like, using a given frequency and timing feedback control scheme. The femtocell may implement continuous observation, if available. At 530, the femtocell may optionally perform Advanced Forward Link Trilateration (AFLT) and/or GPS acquisition, if available, to provide the clock error (e.g. offset) estimate and/or frequency error estimate. At 540, the femtocell may use the results and information gathered at 510-530 to decide which signal or signals should be used for the frequency and timing source for primary and secondary, in case there are multiple useful macro pilots. The Network Listen (NL) operation configuration may be set at 540 as well. The location estimation of the femtocell may be sent to the wireless network so that the network can figure out whether the pilot that the femtocell is referencing to is from a macrocell or another femtocell. At 550, the NL operation, continuous or periodic, for frequency and timing control may be performed based on the configuration setting at block 540, and feedback of the frequency and timing control may be provided to block 540 when outage occurs. In the alternative, or in addition, GPS tracking may be performed at 550.

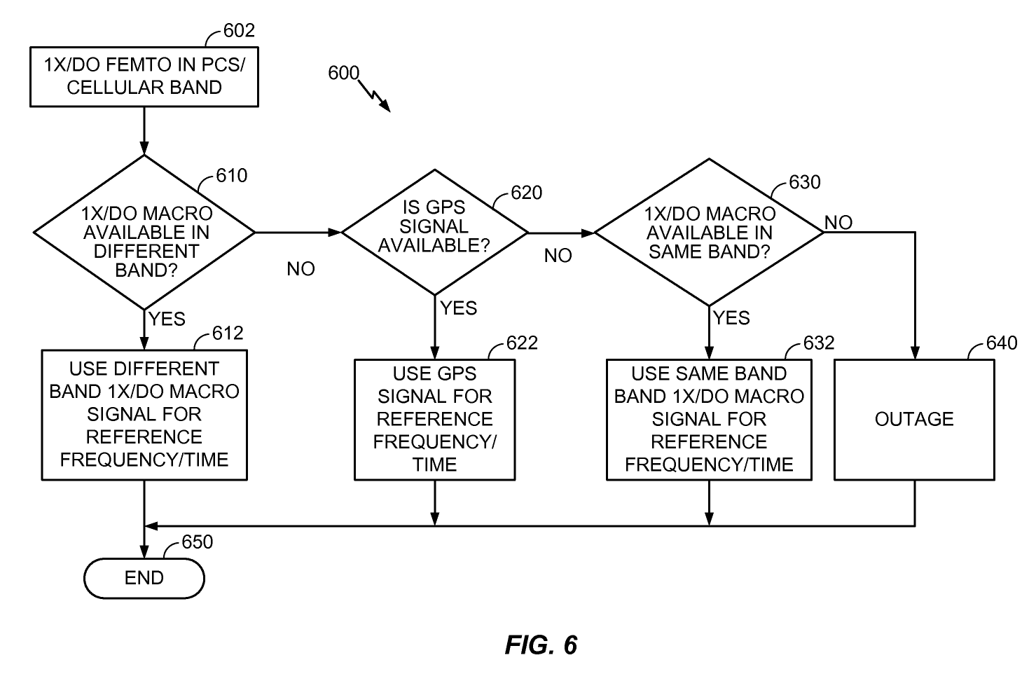

With respect to frequency and timing source selection, the reference signal selection of the femtocell may be based on numerous factors and criteria, including, for example, the operation band, signal availability, etc. With reference to FIG. 6, there is provided a flow diagram for an exemplary method 600 for reference signal selection for a 1x/DO femtocell or the like (e.g., in a Personal Communications Services (PCS)/cellular band). Starting at 602, a given femtocell may be in a given PCS/cellular band. At 610, when there the 1x/DO macro signal is available in different band, the femtocell uses the different band macro signal as the frequency and/or timing reference, at 612. At 620, the femtocell checks the availability of the GPS signal. If the GPS signal is available, it switches to use GPS as its reference, at 622. At 630, when the GPS signal is not available, the femtocell checks the availability of the macro signal at the same band. If the macro signal is available, the femtocell uses the same band macro signal for the reference frequency and/or time, at 632. At 640, if none of the signals are available, the femtocell may operate in free run mode, and may report the outage, and the process ends at 650.

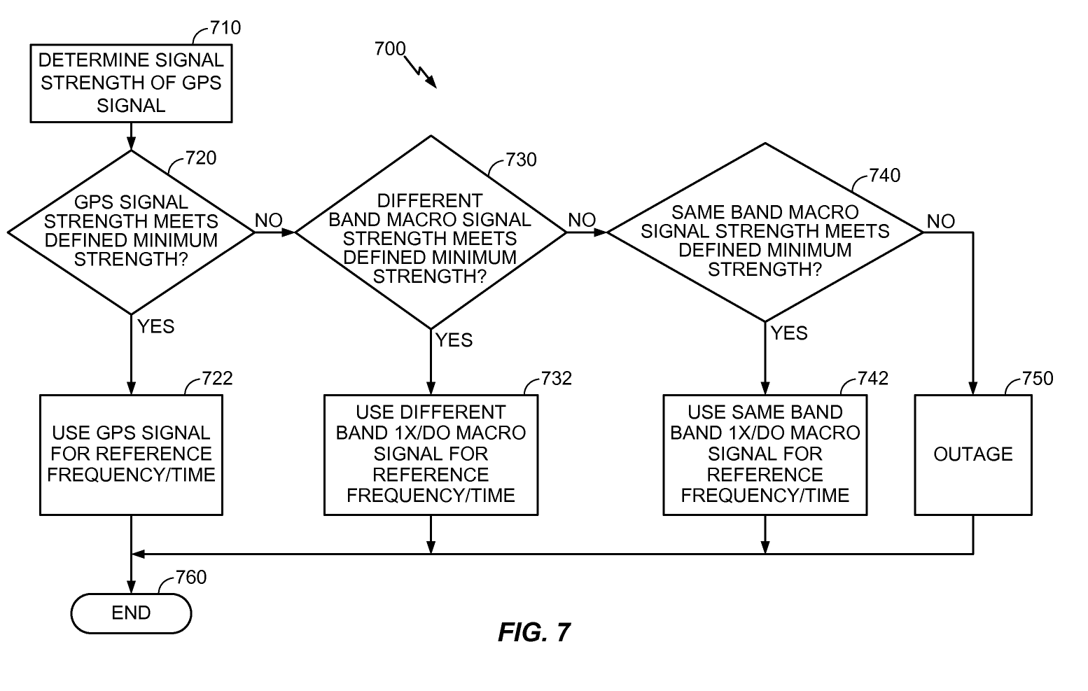

In another approach to reference signal selection for a 1x/DO femtocell or the like, shown in FIG. 7, the method 700 involves having the femtocell default to using the GPS signal, rather than the different band macro signal, for the reference frequency. Such a modified approach would be desirable in situations where the GPS signal is actually stronger or more reliable than the different band macro signal. At 710, the femtocell determines a signal strength of the GPS signal. At 720, the femtocell determines whether the GPS signal strength meets a defined minimum GPS signal strength. If so, the femtocell uses the GPS signal for a frequency and/or timing reference, at 722. If not, at 730, the femtocell determines whether the different band macro signal strength meets a defined minimum macro signal strength. If so, the femtocell uses the different band macro signal for the frequency and/or timing reference, at 732. If not, at 740, the femtocell determines whether the same band macro signal strength meets a defined minimum macro signal strength for the same band. If so, the femtocell uses the same band macro signal for the frequency and/or timing reference, at 742. In effect, the femtocell uses the same band macro signal, in response to detecting that the different band macro signal and the GPS signal are not available. At 750, if none of the signals are available, the femtocell may operate in free run mode, and may report the outage, and the process ends at 760.

In another embodiment (not shown), the femtocell, at 730, simply determines whether the different band macro signal is available, and then, at 732, uses the different band macro signal for the frequency and/or timing reference if available. In the alternative, or in addition, the femtocell, 740, simply determines whether the same band macro signal is available, and then, at 742, uses the same band macro signal for the frequency and/or timing reference if available.

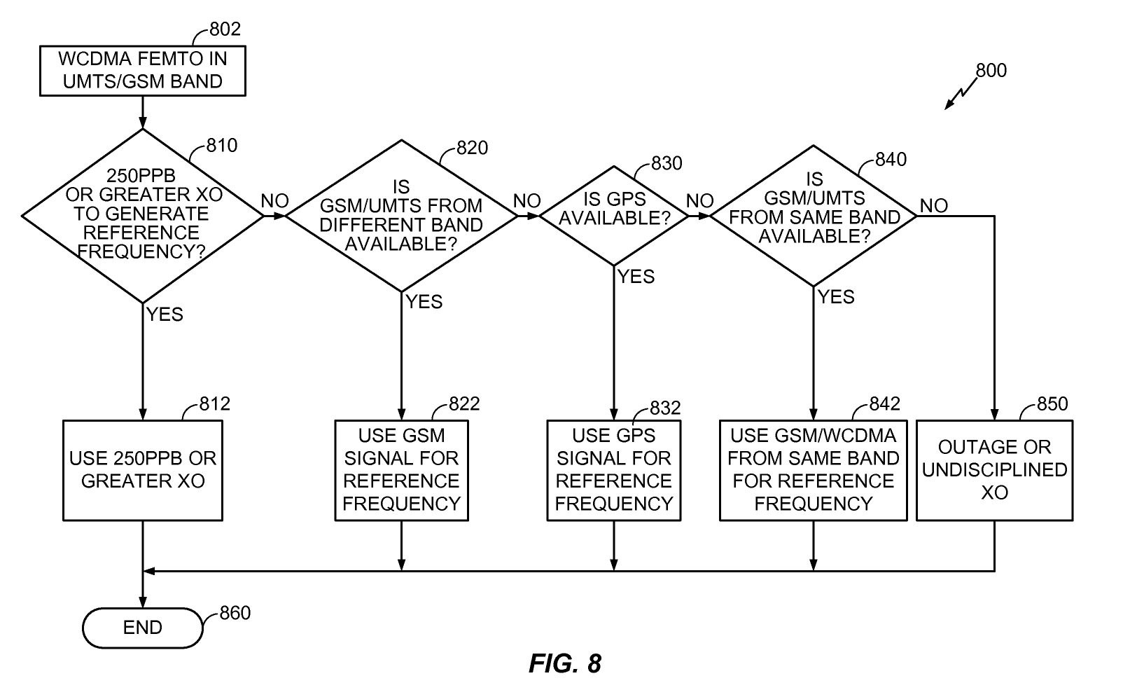

With reference to FIG. 8, there is provided a flow diagram for an exemplary method 800 to reference signal selection for a GSM/UMTS femtocell or the like. Since GSM/UMTS is an asynchronous network, time synchronization is not needed. In addition, since the GSM/UMTS network generally has less stringent frequency requirements than the 1x/DO network, a 250 ppb or greater clock generator (e.g., XO) is believed to be sufficient to generate a reference frequency in a GSM/UMTS femtocell.

With continued reference to FIG. 8, starting at 802, a given femtocell may be in a given UMTS/GSM band. At 810, the femtocell may determine whether an XO or the like of at least 250 ppb is available to generate a reference frequency. If so, the femtocell uses the 250 ppb or greater XO, at 812. If not, the femtocell, at 820, determines whether there is a GSM/UMTS macro signal available in a different band. If so, the femtocell uses the different band macro signal as the frequency reference, at 822. If not, the femtocell, at 830, checks the availability of the GPS signal. If the GPS signal is available, it uses GPS as its reference, at 832. At 840, when the GPS signal is not available, the femtocell determines whether there is a GSM/UMTS macro signal available in the same band. If so, the femtocell uses the same band macro signal as the frequency reference, at 842. At 850, if none of the signals are available, the femtocell may report the outage, and the process ends at 860.

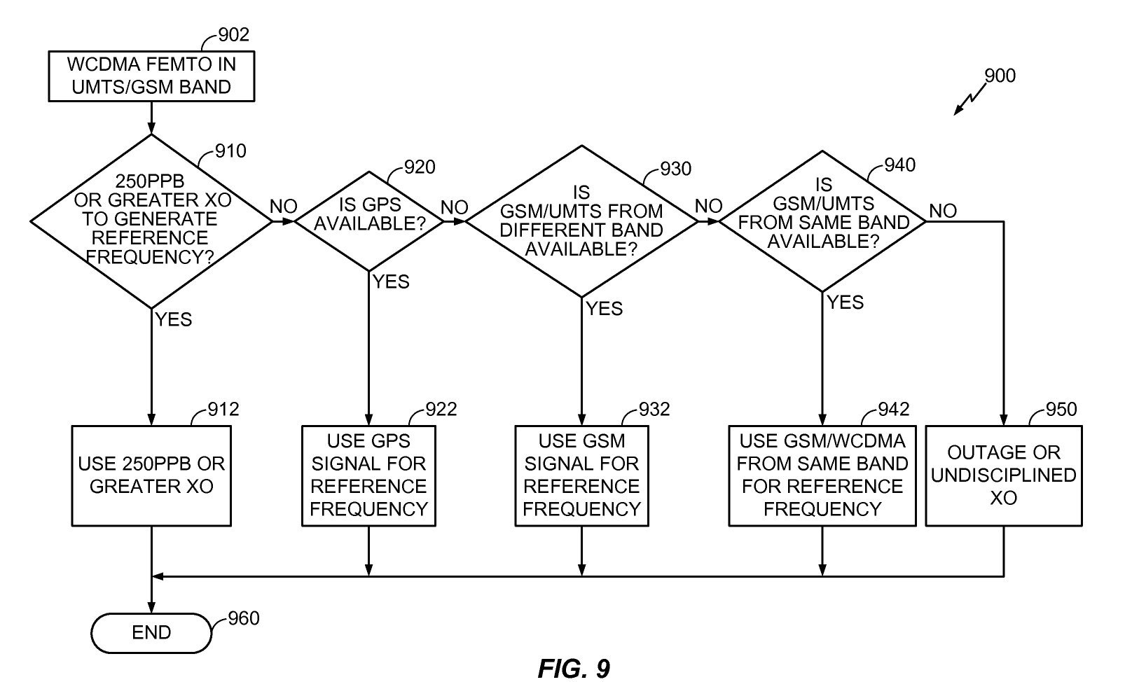

In another approach to reference signal selection for a GSM/UMTS femtocell or the like, shown in FIG. 9, the femtocell determines in a manner that is similar to the approach shown in FIG. 8. However, when an XO or the like of at least 250 ppb is not available, the femtocell defaults to using the GPS signal, rather than the different band macro signal, for the reference frequency, at 920-922. If the GPS signal is too weak or otherwise not available, the femtocell may use the different band macro signal for the reference frequency, at 930-932. If the different band macro signal is too weak or otherwise not available, the femtocell resorts to using the same band macro signal for the reference frequency (if available), at 940-942. The rest of the approach shown in FIG. 9 is analogous to the approach of FIG. 8.

As explained above with reference to FIGS. 6-9, the reference signal for the femtocell could be a macro signal in a different band, a GPS signal, or a macro signal in the same band. In the scenario where the GPS signal or the different band macro signal is used as the frequency reference, the existing frequency control scheme may be used to control the frequency of the femtocell. However, a different frequency control scheme should be used to stabilize a Voltage Controlled Temperature Compensated Crystal Oscillator (VCTCXO) or other clock generator of the femtocell based on the macro signal when they are operating in the same band.

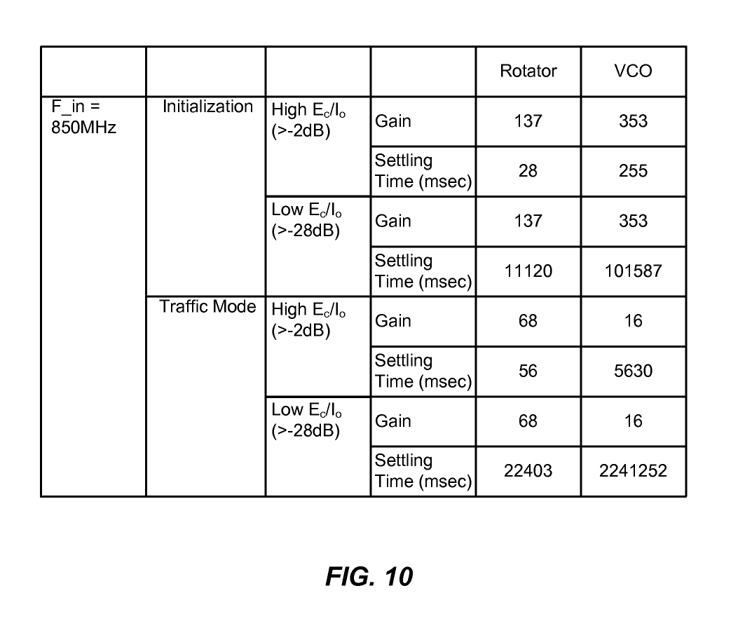

For example, when femtocell operates at the same band as the macrocell, the femtocell may shut down its transmission in order to receive the macro signal for VCTCXO stabilization, such as for example, in Discontinuous Transmission (DTX) mode. However, the DTX mode may not be desirable for the femtocell user since it may introduce frame loss or other performance degradation. Therefore, when the femtocell is in the DTX mode, a slotted idle mode operation may be adopted to discipline the VCTCXO. In normal operation of a modem chipset, the settling time (e.g. four times the time constant of the loop) of the AFC may be longer than a defined time period, such as, for example, 20 msec. In such a scenario, the femtocell transmission shut down period should to be longer than 20 msec in order to discipline the VCTCXO. The table in FIG. 10 summarizes exemplary settling times for different scenarios, including initialization vs. traffic modes and different signal-to-noise ratio (E_{c}/Iₒ) levels.

In related aspects, there is provided a method for disciplining a clock generator, such as a VCTCXO or the like, by using a higher gain for a rotator to reduce settling time, and/or using the last few msec (T_{Rot}) of rotator measurements. In addition, the method may involve using the proper filter to smooth the fluctuations in the rotator measurements in the feedback loop. The feedback loop may involve making use of frequency error measurements over a multiple number of slots (N_{DTX}) to further reduce the effect of fluctuations due to noise, etc.

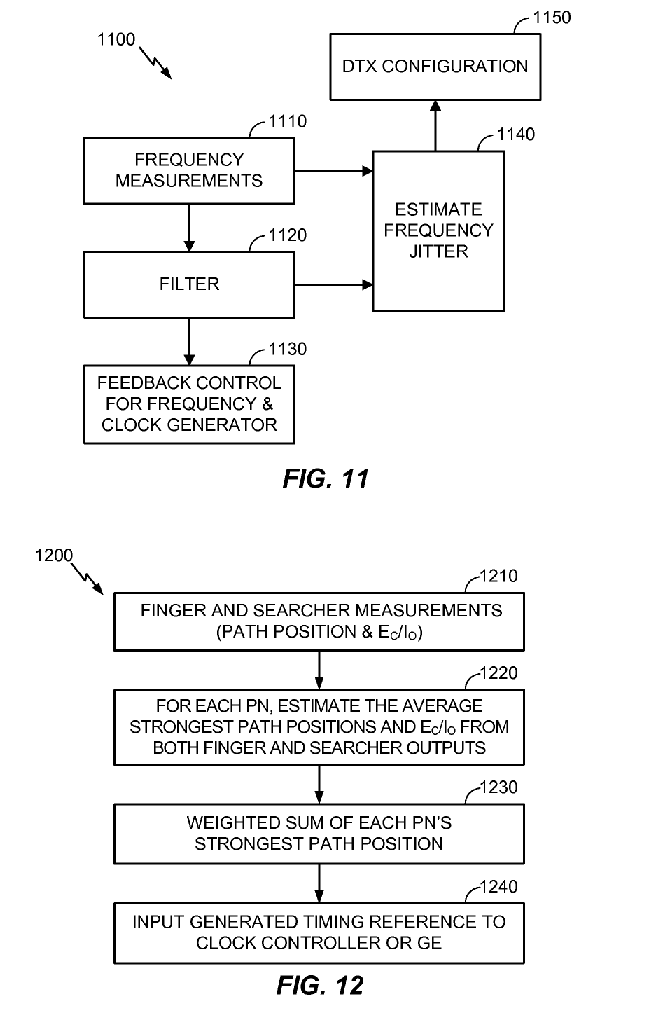

With reference to FIG. 11, there is provided a flow chart for a frequency control method 1100 when the femtocell uses a same band macro signal for feedback control of the clock generator. The techniques may involve, at 1110, obtaining frequency measurements by observing macro base station signals, and filtering the frequency measurements with a low-pass filter to reduce noise effects, at 1120. The noise-reduced frequency measurement may be used in the feedback control loop(s) to the frequency and clock generator (e.g., an XO), at 1130. The frequency measurements from block 1120 and/or the filter outputs from block 1130 may also be used to estimate the size of frequency jitters, at 1140. At 1150, the estimated frequency jitters may be used in the feedback to the DTX operation settings (e.g., how often the femtocell observes the macro base station signals and/or the duration of each observation period). If the observed frequency error is below a defined value, then the DTX operation may be performed less often, and/or the duration of each DTX operation could be made shorter.

In accordance with one or more aspects of the embodiments described herein, for stationary environments, including, for example, femtocell deployment scenarios, the strongest finger is believed to be more stable in terms of timing jitter than the earliest fingers. Accordingly, the timing control protocol may utilize the strongest fingers of the Pseudo-Noise (PN) to generate the timing reference for the femtocell, and/or may utilize the strongest available finger measurement(s) to reduce the effect of clock slew.

In related aspects, there is provided a timing control technique for continuous tracking mode, when the femtocell utilizes a different band macro signal as the timing reference (i.e., when the femtocell and the macrocell are in different bands). With reference to FIG. 12, there is provided a flow diagram that illustrates a method 1200 for timing reference generation for a femtocell. At 1210, finger and searcher measurements are made, including, for example, the path position and the signal-to-noise ratio (E_{c}/Iₒ). At 1220, for each PN in the candidate and active sets, the average finger positions and E_{c}/Iₒ of the strongest fingers of the PNs. In addition, the average path positions and E_{c}/Iₒ of the strongest paths of other useful PNs (e.g., PNs that are outside the active and the candidate sets, but their strongest paths having E_{c}/Iₒ>threshold-for-search (TH_{search})) are also estimated from the searcher output. The path position can be the code phase of each multi-path component reported by the searcher, and this path position can be interpolated to chipx8 or the like when combined with finger position measurements. At 1230, the finger positions and the E_{c}/Iₒ (for weighting) of the strongest finger, as well as those measurements of the strongest paths of the useful PNs from searcher output, may be used to generate the timing reference, such as, for example by taking the weighted sum of each PN's strongest path position. At 1240, the generated timing reference may be input to the clock controller or the generator (GE).

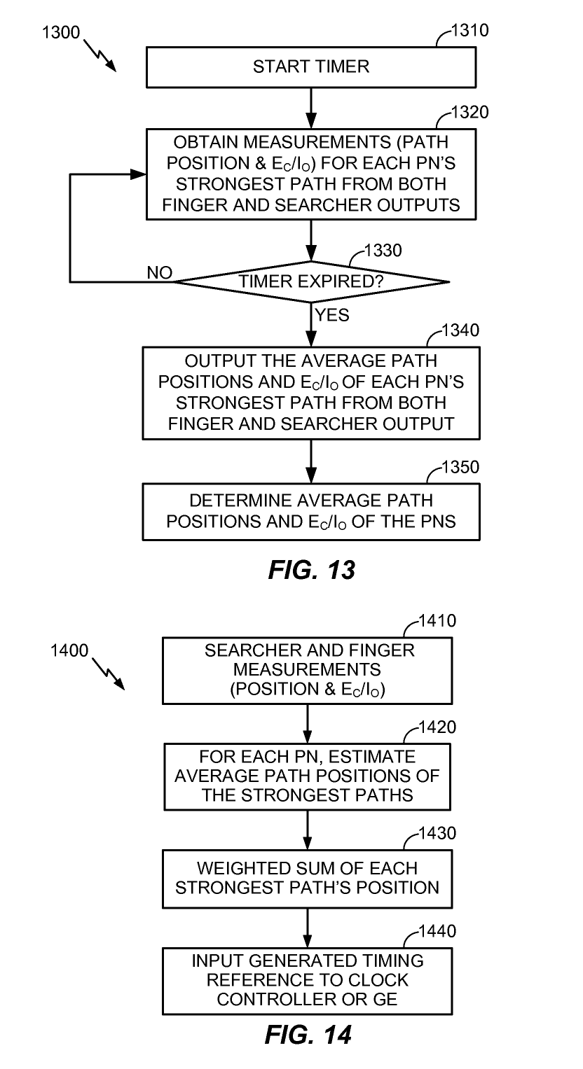

With reference to FIG. 13, there is provided a flow diagram that illustrates a method 1300 for estimating the average path positions of the PNs in the timing reference generation method of FIG. 12, at block 1220. At 1310, the timer and process may be started. At 1320, the strongest finger measurements (e.g., finger position and E_{c}/Iₒ) for the active and the candidate sets of PNs are obtained. Searcher measurements of the strongest paths for useful PNs (PNs outside the active and the candidate sets, but their strongest paths having E_{c}/Iₒ>TH_{search}) are obtained. At 1330, it is determined whether the predefined timer has expired. If not, the method 1300 returns to 1320; otherwise, the method 1300 continues to 1340, where the average finger positions and E_{c}/Iₒ of the strongest finger for each PN (from the finger and/or search outputs) may be updated. At 1350, the average path positions and the E_{c}/Iₒ of the strongest paths for the useful PNs are determined based on the searcher output.

In further related aspects, after 1340, the average position(s) and E_{c}/Iₒ estimate(s) may be sent to block 1230 of FIG. 12. The timing reference (the clock rate and the clock offset) generation at 1230 may be based on new measurements. Once a new measurement is obtained, the timing reference may be updated using the new observations and the previous estimated average of the path positions and strength, according to the following equation:

$$P = {\sum }_{i ∈ U} {w}_{i} ( {P}_{i} - {\overline{P}}_{i} ) \qquad ( Equation \text{-} 1 )$$

where U is the current path positions measurement sets (including the finger measurements and searcher measurements with E_{c}/Iₒ>TH_{search}), P is the timing reference for femtocell, Pᵢ are the strongest finger positions and the strongest path positions of the useful PNs from the searcher output, P̅ᵢ is their average, and wᵢ is the weight for each PN. The value of wᵢ may depend on its corresponding average (or instantaneous) E_{c}/Iₒ.

After the timing reference (e.g., the clock rate and the eclock offset) is updated, the average finger positions and the E_{c}/Iₒ of the strongest finger, as well as the average positions and the E_{c}/Iₒ of the strongest paths corresponding to useful PNs may be updated.

In yet further related aspects, there is provided a timing control technique for when the femtocell utilizes a same band macro signal as the timing reference. When femtocell operates in the same band as macrocell, the DTX can be used to generate the timing reference for the femtocell. It may be assumed that during the DTX, the femtocell operates in slotted idle mode, and that the modem chipset tracks one PN, and that the earliest finger of that PN is used as the timing reference for the modem chipset. In such a scenario, the timing control method may accommodate the different operation of the modem chipset of the femtocell or the like.

When the slotted idle mode is used, the average path positions and the E_{c}/Iₒ may be estimated using the searcher and finger output of the previous predefined number of N_{DTX} slots. After such estimations are completed, the timing reference may be updated at each slot according to the method 1400 shown as a flow diagram in FIG. 14. At 1410, searcher and finger measurements are made, including, for example, the path position and the E_{c}/Iₒ. At 1420, the average path positions and the E/Iₒ of the strongest paths may be estimated for the useful PNs (e.g., E_{c}/Iₒ>TH_{search}). The path position may be the code phase of each multi-path component reported by the searcher and the strongest finger. At 1430, the average position and the E_{c}/Iₒ of the strongest paths may be used to generate the timing reference (e.g., by taking the weighted sum of each PN's strongest path position), as described above with reference to FIG. 12. At 1440, the generated timing reference may be input to the clock controller or generator.

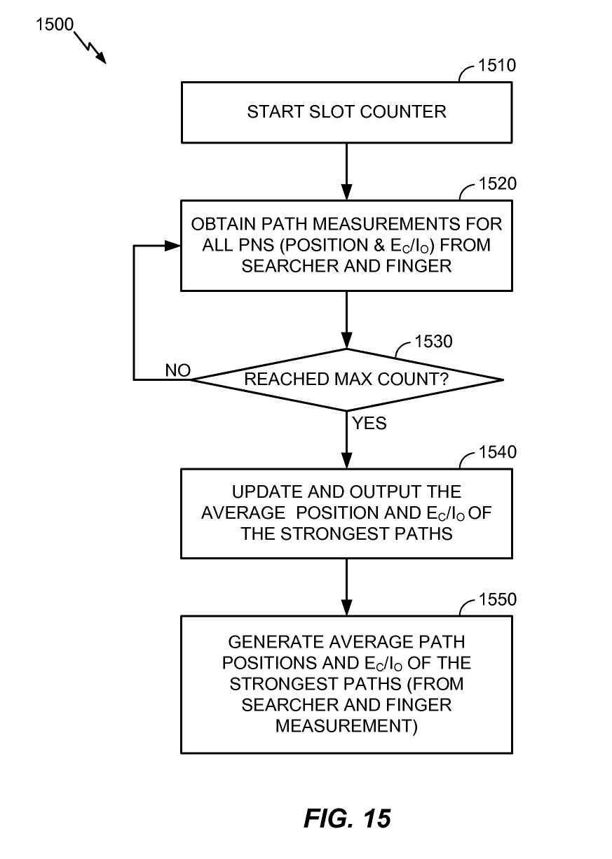

With reference to FIG. 15, there is provided a flow diagram that illustrates a method 1500 for estimating the average path positions of the PNs at block 1420 of FIG. 14. Method 1500 of FIG. 15 is similar to method 1400 of FIG. 14, except that the statistics of the average path positions and the E_{c}/Iₒ are obtained via multiple slot observation. At 1510, the slot timer and process may be started. At 1520, the path positions and the E_{c}/Iₒ from the re-acquisition search and the prior search outputs for PNs with E_{c}/Iₒ>TH_{search}, as well as the strongest finger path position and E_{c}/Iₒ, are obtained. At 1530, in response to a counter value reaching a predefined maximum count value, the method 1500 proceeds to block 1540; otherwise the method 1500 returns to block 1520. At 1540, the average path positions and the E_{c}/Iₒ of the strongest paths for the useful PNs may be updated and sent to block 1430 of the method 1400. In addition, at 1550, the average path position and the E_{c}/Iₒ of the strongest finger may be generated and sent to block 1430. The searcher output may be interpolated to chipx8 or the like when combined with finger position measurements. In one embodiment, the timing reference of the femtocell may be updated using Equation-1 at the next slot. At the next wake-up slot, the re-acquisition search and prior search outputs, as well as the finger measurements, may be used to update the timing reference using Equation-1 or the like. After the timing reference is updated, the average path positions and the E_{c}/Iₒ of the strongest paths (from the finger and the searcher outputs) may be updated.

In view of exemplary systems shown and described herein, methodologies that may be implemented in accordance with the disclosed subject matter, will be better appreciated with reference to various flow charts. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

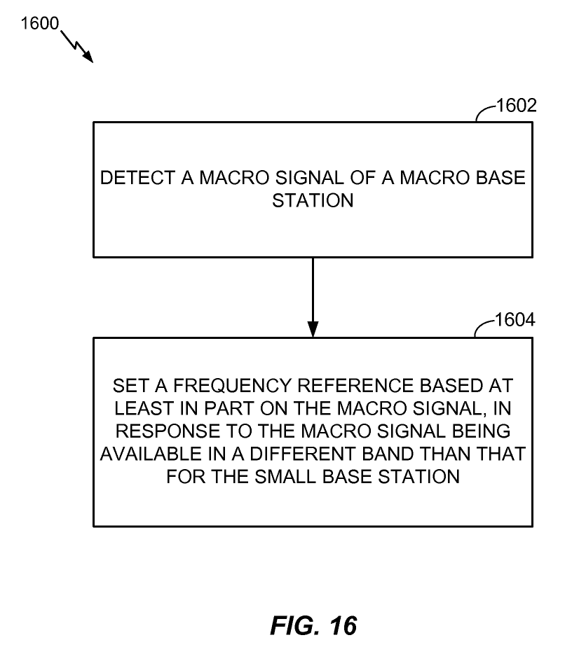

With reference to FIG. 16, illustrated is a methodology 1600 for frequency and/or timing synchronization with a wireless communication network. It is noted that the method 1600 may be performed at a small base node (e.g., a selected one of a femto access point, a home base node, a closed subscription cell, etc.). For example, the method 1600 may involve, at 1602, detecting a macro signal of a macro base station. The method 1600 may involve, at 1604, setting a frequency reference based at least in part on the macro signal, in response to the macro signal being available in a different band than that for the small base station.

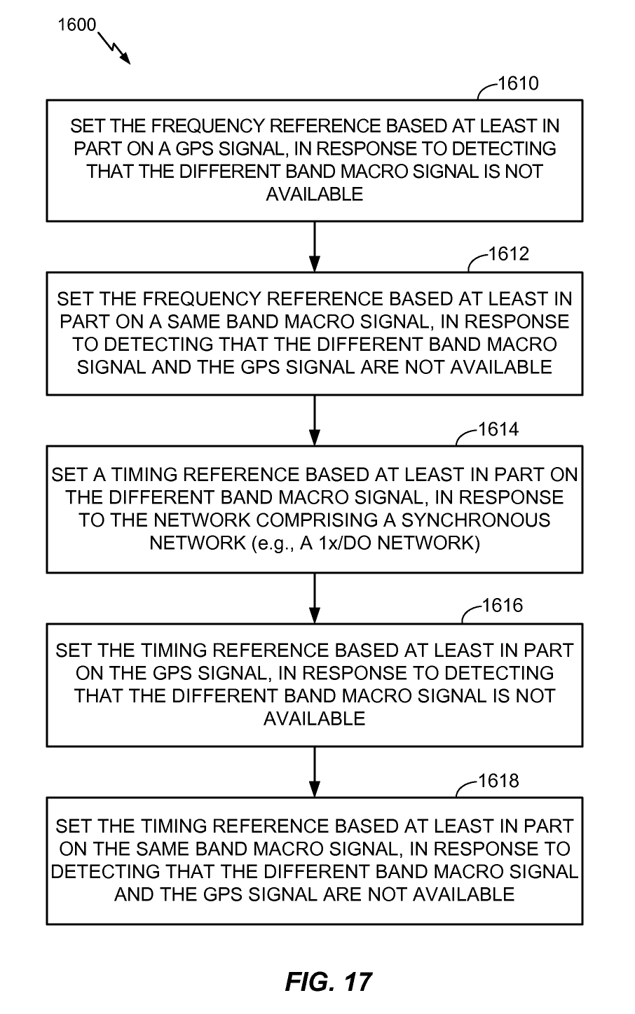

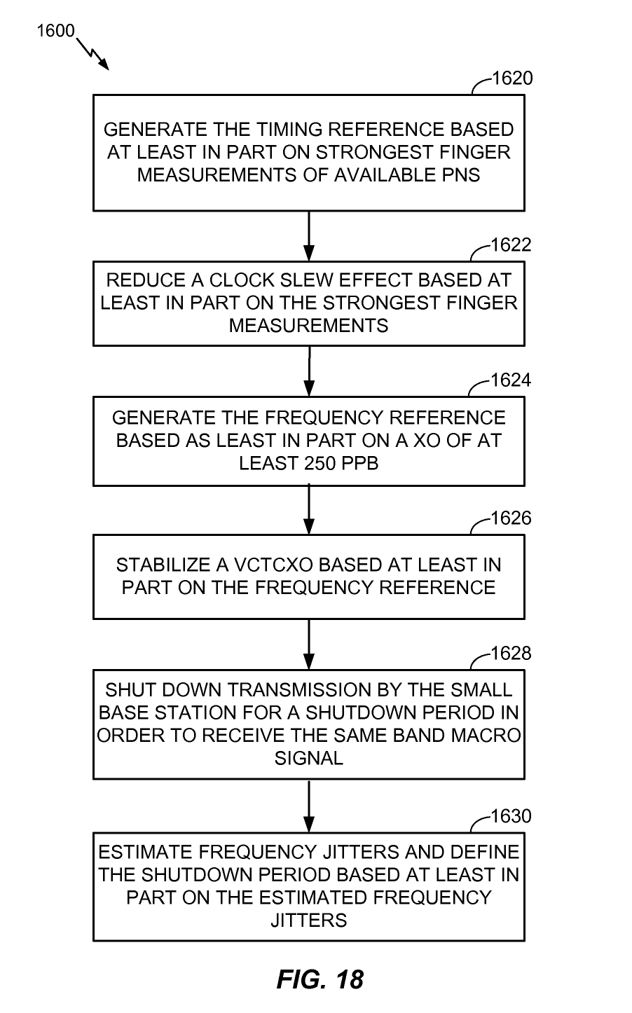

With reference to FIG. 17, there are shown further operations or aspects of method 1600 that are optional and may be performed by a small base node for frequency and/or timing synchronization. It is noted that the blocks shown in FIGS. 17-18 are not required to perform the method 1600. If the method 1600 includes at least one block of FIGS. 17-18, then the method 1600 may terminate after the at least one block, without necessarily having to include any subsequent downstream block(s) that may be illustrated. It is further noted that numbers of the blocks do not imply a particular order in which the blocks may be performed according to the method 1600. For example, the method 1600 may involve, at 1610, setting the frequency reference based at least in part on a GPS signal, in response to detecting that the different band macro signal is not available. The method 1600 may involve, at 1612, setting the frequency reference based at least in part on a same band macro signal, in response to detecting that the different band macro signal and the GPS signal are not available.

In related aspects, the method 1600 may involve, at 1614, setting a timing reference based at least in part on the different band macro signal, in response to the network comprising a synchronous network (e.g., a 1x/DO network). The method 1600 may involve, at 1616, setting the timing reference based at least in part on the GPS signal, in response to detecting that the different band macro signal is not available. The method 1600 may involve, at 1618, setting the timing reference based at least in part on the same band macro signal, in response to detecting that the different band macro signal and the GPS signal are not available.

With reference to FIG. 18, the method 1600 may involve, at 1620, generating the timing reference based at least in part on strongest finger measurements of available PNs. The method 1600 may involve, at 1622, reducing a clock slew effect based at least in part on the strongest finger measurements.

In related aspects, the network may include an asynchronous network, such as, for example, a GSM/UMTS network. The method 1600 may involve, at 1624, generating the frequency reference based as least in part on a XO of at least 250 ppb. The method 1600 may involve, at 1626, stabilizing a VCTCXO based at least in part on the frequency reference.

In further related aspects, setting the frequency reference based at least in part on the same band macro signal may involve, at 1628, shutting down transmission by the small base station for a shutdown period in order to receive the same band macro signal. The method 1600 may involve, at 1630, estimating frequency jitters and defining the shutdown period based at least in part on the estimated frequency jitters.

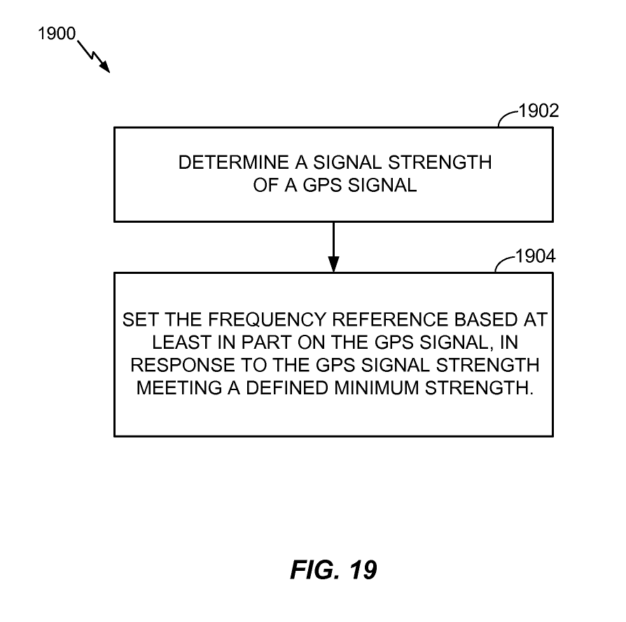

With reference to FIG. 19, illustrated is another methodology 1900 for facilitating frequency and/or timing synchronization with a wireless communication network. For example, the method 1900 may be performed at a small base node and may involve, at 1902, determining a signal strength of a GPS signal. The method 1900 may involve, at 1904, setting the frequency reference based at least in part on the GPS signal, in response to the GPS signal strength meeting a defined minimum strength.

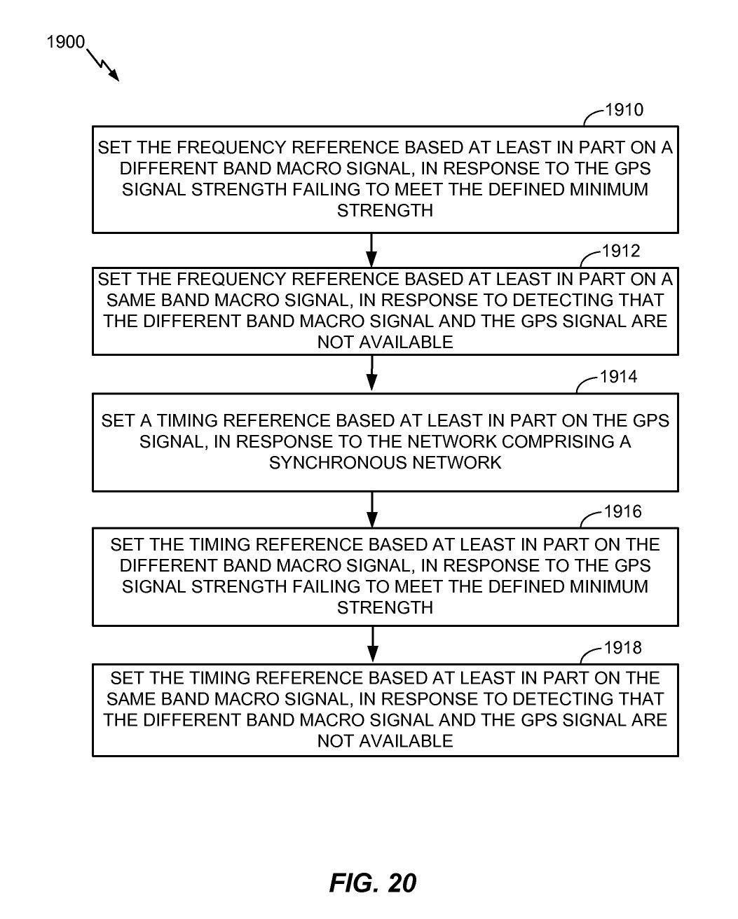

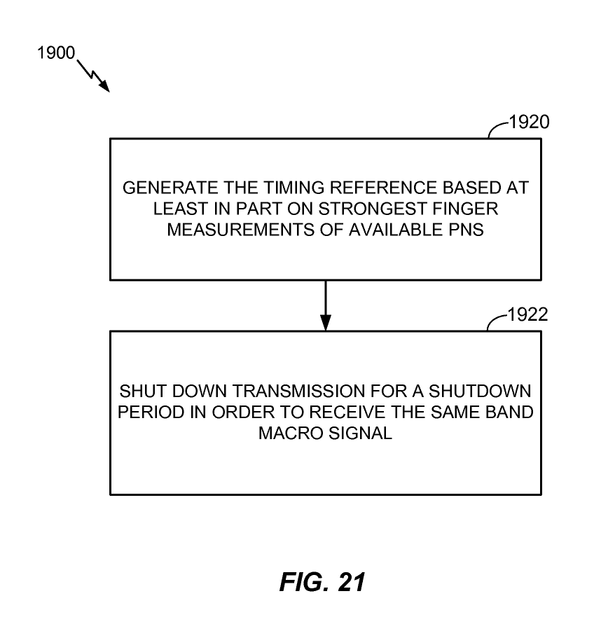

With reference to FIG. 20, there are shown further operations or aspects of method 1900 that are optional for frequency and/or timing synchronization. It is noted that the blocks shown in FIGS. 20-21 are not required to perform the method 1900. If the method 1900 includes at least one block of FIGS. 20-21, then the method 1900 may terminate after the at least one block, without necessarily having to include any subsequent downstream block(s) that may be illustrated. It is further noted that numbers of the blocks do not imply a particular order in which the blocks may be performed according to the method 1900. For example, the method 1900 may involve, at 1910, setting the frequency reference based at least in part on a different band macro signal, in response to the GPS signal strength failing to meet the defined minimum strength. The method 1900 may involve, at 1912, setting the frequency reference based at least in part on a same band macro signal, in response to detecting that the different band macro signal and the GPS signal are not available.

In related aspects, the method 1900 may involve, at 1914, setting a timing reference based at least in part on the GPS signal, in response to the network comprising a synchronous network. The method 1900 may involve, at 1916, setting the timing reference based at least in part on the different band macro signal, in response to the GPS signal strength failing to meet the defined minimum strength. The method 1900 may involve, at 1918, setting the timing reference based at least in part on the same band macro signal, in response to detecting that the different band macro signal and the GPS signal are not available.

With reference to FIG. 21, the method 1900 may involve, at 1920, generating the timing reference based at least in part on strongest finger measurements of available PNs. In related aspects, the network may include an asynchronous network. In yet further related aspects, setting the frequency reference based at least in part on the same band macro signal may involve, at 1922, shutting down transmission for a shutdown period in order to receive the same band macro signal.

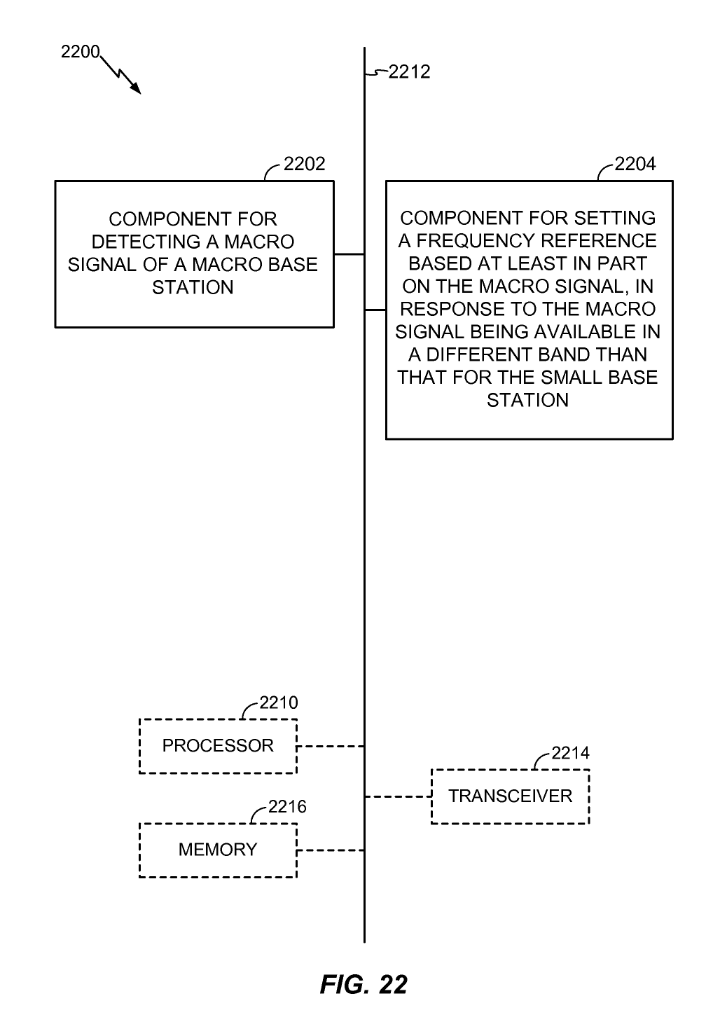

In accordance with one or more aspects of the embodiments described herein, there are provided devices and apparatuses for frequency and timing synchronization of a small base node, as described above with reference to FIGS. 16-18. With reference to FIG. 22, there is provided an exemplary apparatus 2200 that may be configured as a small base node, or as a processor or similar device for use within the small base node. The apparatus 2200 may include functional blocks that can represent functions implemented by a processor, software, or combination thereof (e.g., firmware).

For example, the apparatus 2200 of FIG. 22 may comprise an electrical component or module 2202 for detecting a macro signal of a macro base station. The apparatus 2200 may comprise an electrical component 2204 for setting a frequency reference based at least in part on the macro signal, in response to the macro signal being available in a different band than that for the small base station.

In related aspects, the apparatus 2200 may optionally include a processor component 2210 having at least one processor, in the case of the apparatus 2200 configured as a network entity, rather than as a processor. The processor 2210, in such case, may be in operative communication with the components 2202-2204 via a bus 2212 or similar communication coupling. The processor 2210 may effect initiation and scheduling of the processes or functions performed by electrical components 2202-2204.

In further related aspects, the apparatus 2200 may include a radio transceiver component 2214. A stand alone receiver and/or stand alone transmitter may be used in lieu of or in conjunction with the transceiver 2214. The apparatus 2200 may optionally include a component for storing information, such as, for example, a memory device/component 2216. The computer readable medium or the memory component 2216 may be operatively coupled to the other components of the apparatus 2200 via the bus 2212 or the like. The memory component 2216 may be adapted to store computer readable instructions and data for effecting the processes and behavior of the components 2202-2204, and subcomponents thereof, or the processor 2210, or the methods disclosed herein. The memory component 2216 may retain instructions for executing functions associated with the components 2202-2204. While shown as being external to the processor 2210, the transceiver 2214, and the memory 2216, it is to be understood that one or more of the components 2202-2204 can exist within the processor 2210, the transceiver 2214, and/or the memory 2216.

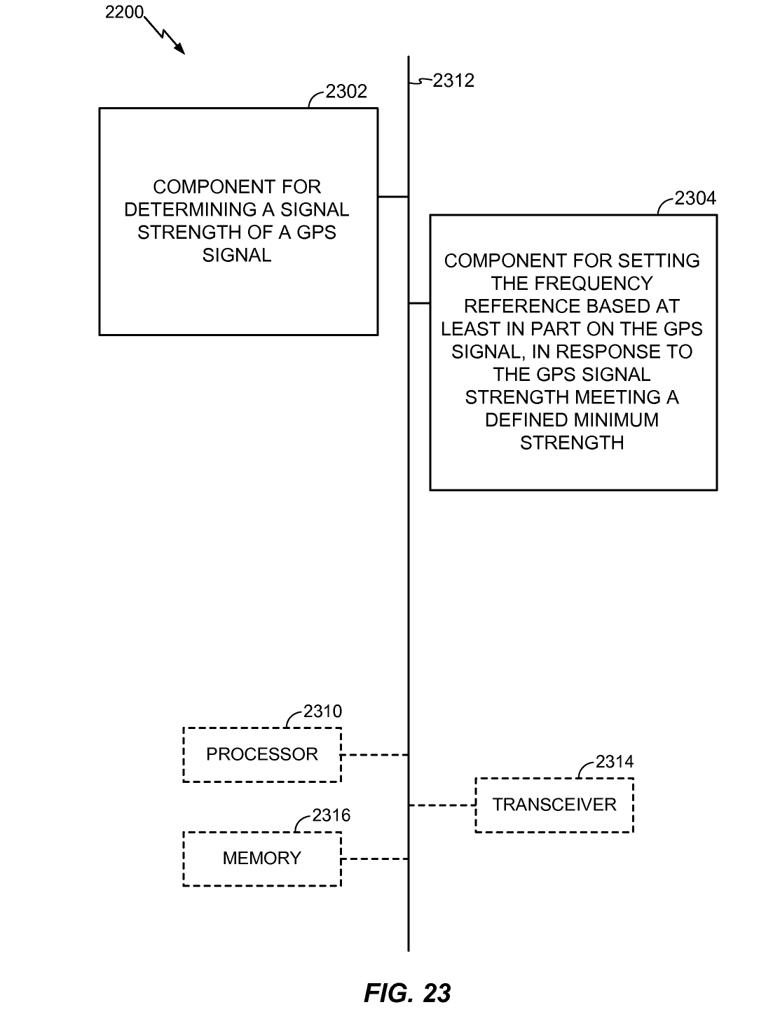

In accordance with one or more aspects of the embodiments described herein, there are provided devices or apparatuses configured for synchronization of a small base station, as described above with reference to FIGS. 19-21. With reference to FIG. 23, the apparatus 2300 may comprise an electrical component or module 2302 for determining a signal strength of a GPS signal. The apparatus 2300 may comprise an electrical component 2304 for setting the frequency reference based at least in part on the GPS signal, in response to the GPS signal strength meeting a defined minimum strength. For the sake of conciseness, the rest of the details regarding apparatus 2300 are not further elaborated on; however, it is to be understood that the remaining features and aspects of the apparatus 2300 are substantially similar to those described above with respect to apparatus 2200 of FIG. 22.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or non-transitory wireless technologies, then the coaxial cable, fiber optic cable, twisted pair, DSL, or the non-transitory wireless technologies are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for synchronization with a network by a small base station, comprising:
detecting a macro signal of a macro base station; and
setting a frequency reference based at least in part on the macro signal, in response to the macro signal being available in a different band than that for the small base station.

2. The method of claim 1, further comprising setting the frequency reference based at least in part on a Global Positioning System (GPS) signal, in response to detecting that the different band macro signal is not available.

3. The method of claim 2, further comprising setting the frequency reference based at least in part on a same band macro signal, in response to detecting that the different band macro signal and the GPS signal are not available.

4. The method of claim 3 further comprising setting a timing reference based at least in part on the different band macro signal, in response to the network comprising a synchronous network.

5. The method of claim 4, wherein the synchronous network comprises a 1x/DO network.

6. The method of claim 4, further comprising setting the timing reference based at least in part on the GPS signal, in response to detecting that the different band macro signal is not available.

7. The method of claim 6, further comprising setting the timing reference based at least in part on the same band macro signal, in response to detecting that the different band macro signal and the GPS signal are not available.

8. The method of claim 7, further comprising generating the timing reference based at least in part on strongest finger measurements of available PNs.

9. The method of claim 8, further comprising reducing a clock slew effect based at least in part on the strongest finger measurements.

10. The method of claim 1, wherein the network comprises an asynchronous network.

11. The method of claim 10, wherein the asynchronous network comprises a Global System for Mobile communications (GSM)/Universal Mobile Telecommunications System (UMTS) network.

12. The method of claim 11, further comprising generating the frequency reference based as least in part on a Crystal Oscillator (XO) of at least 250 ppb.

13. The method of claim 1, further comprising stabilizing a Voltage Controlled Temperature Compensated Crystal Oscillator (VCTCXO) based at least in part on the frequency reference.

14. The method of claim 3, wherein setting the frequency reference based at least in part on the same band macro signal comprises shutting down transmission by the small base station for a shutdown period in order to receive the same band macro signal.

15. The method of claim 14, further comprising:
estimating frequency jitters; and
defining the shutdown period based at least in part on the estimated frequency jitters.

16. A method for synchronization with a network, comprising:
determining a signal strength of a Global Positioning System (GPS) signal; and
setting the frequency reference based at least in part on the GPS signal, in response to the GPS signal strength meeting a defined minimum strength.

17. The method of claim 16, further comprising setting the frequency reference based at least in part on a different band macro signal, in response to the GPS signal strength failing to meet the defined minimum strength.

18. The method of claim 17, further comprising setting the frequency reference based at least in part on a same band macro signal, in response to detecting that the different band macro signal and the GPS signal are not available.

19. The method of claim 18, further comprising setting a timing reference based at least in part on the GPS signal, in response to the network comprising a synchronous network.

20. The method of claim 19, further comprising setting the timing reference based at least in part on the different band macro signal, in response to the GPS signal strength failing to meet the defined minimum strength.

21. The method of claim 20, further comprising setting the timing reference based at least in part on the same band macro signal, in response to detecting that the different band macro signal and the GPS signal are not available.

22. The method of claim 21, further comprising generating the timing reference based at least in part on strongest finger measurements of available PNs.

23. The method of claim 16, wherein the network comprises an asynchronous network.

24. The method of claim 18, wherein setting the frequency reference based at least in part on the same band macro signal comprises shutting down transmission for a shutdown period in order to receive the same band macro signal.

25. An apparatus operable in a wireless communication system, the apparatus synchronizing with a network and comprising:
means for detecting a macro signal of a macro base station; and
means for setting a frequency reference based at least in part on the macro signal, in response to the macro signal being available in a different band than that for the small base station.

26. The apparatus of claim 25, further comprising means for setting the frequency reference based at least in part on a Global Positioning System (GPS) signal, in response to detecting that the different band macro signal is not available.

27. The apparatus of claim 26, further comprising means for setting the frequency reference based at least in part on a same band macro signal, in response to detecting that the different band macro signal and the GPS signal are not available.

28. The apparatus of claim 25, wherein the apparatus comprises a femto base station.

29. The apparatus of claim 27, further comprising means for setting a timing reference based at least in part on the different band macro signal, in response to the network comprising a synchronous network.

30. The apparatus of claim 29, further comprising means for setting the timing reference based at least in part on the GPS signal, in response to detecting that the different band macro signal is not available.

31. The apparatus of claim 30, further comprising means for setting the timing reference based at least in part on the same band macro signal, in response to detecting that the different band macro signal and the GPS signal are not available.

32. The apparatus of claim 31, further comprising means for generating the timing reference based at least in part on strongest finger measurements of available PNs.

33. The apparatus of claim 25, wherein the network comprises an asynchronous network.

34. The apparatus of claim 27, wherein the means for setting the frequency reference based at least in part on the same band macro signal comprises means for shutting down transmission for a shutdown period in order to receive the same band macro signal.

35. An apparatus operable in a wireless communication system, the apparatus synchronizing with a network and comprising:
means for determining a signal strength of a Global Positioning System (GPS) signal; and
means for setting the frequency reference based at least in part on the GPS signal, in response to the GPS signal strength meeting a defined minimum strength.

36. The apparatus of claim 35, further comprising means for setting the frequency reference based at least in part on a different band macro signal, in response to the GPS signal strength failing to meet the defined minimum strength.

37. The apparatus of claim 36, further comprising means for setting the frequency reference based at least in part on a same band macro signal, in response to detecting that the different band macro signal and the GPS signal are not available.

38. The apparatus of claim 35, further comprising means for setting the timing reference based at least in part on the GPS signal, in response to the network comprising a synchronous network.

39. A computer program product, comprising:
a computer-readable medium comprising code for causing a computer to:
detect a macro signal of a macro base station; and
set a frequency reference based at least in part on the macro signal, in response to the macro signal being available in a different band than that for the small base station.

40. The computer program product of claim 39, wherein the computer-readable medium further comprises code for causing the computer to set the frequency reference based at least in part on a Global Positioning System (GPS) signal, in response to detecting that the different band macro signal is not available.

41. The computer program product of claim 40, wherein the computer-readable medium further comprises code for causing the computer to set the frequency reference based at least in part on a same band macro signal, in response to detecting that the different band macro signal and the GPS signal are not available.

42. The computer program product of claim 41, wherein the computer-readable medium further comprises code for causing the computer to set a timing reference based at least in part on the different band macro signal, in response to the network comprising a synchronous network.

43. The computer program product of claim 42, wherein the computer-readable medium further comprises code for causing the computer to set a timing reference based at least in part on the GPS signal, in response to detecting that the different band macro signal is not available.

44. The computer program product of claim 43, wherein the computer-readable medium further comprises code for causing the computer to set a timing reference based at least in part on the same band macro signal, in response to detecting that the different band macro signal and the GPS signal are not available.

45. The computer program product of claim 44, wherein the computer-readable medium further comprises code for causing the computer to generate the timing reference based at least in part on strongest finger measurements of available PNs.

46. A computer program product, comprising:
a computer-readable medium comprising code for causing a computer to:
determine a signal strength of a Global Positioning System (GPS) signal; and
set the frequency reference based at least in part on the GPS signal, in response to the GPS signal strength meeting a defined minimum strength.

47. The computer program product of claim 46, wherein the computer-readable medium further comprises code for causing the computer to set the frequency reference based at least in part on a different band macro signal, in response to the GPS signal strength failing to meet the defined minimum strength.

48. The computer program product of claim 47, wherein the computer-readable medium further comprises code for causing the computer to set the frequency reference based at least in part on a same band macro signal, in response to detecting that the different band macro signal and the GPS signal are not available.

49. The computer program product of claim 46, wherein the computer-readable medium further comprises code for causing the computer to set a timing reference based at least in part on the GPS signal, in response to the network comprising a synchronous network.

50. An apparatus operable in a wireless communication system, the apparatus synchronizing with a network and comprising:
at least one processor configured to: detect a macro signal of a macro base station; and set a frequency reference based at least in part on the macro signal, in response to the macro signal being available in a different band than that for the small base station; and
a memory coupled to the at least one processor for storing data.

51. The apparatus of claim 50, wherein the at least one processor sets the frequency reference based at least in part on a Global Positioning System (GPS) signal, in response to detecting that the different band macro signal is not available.

52. The apparatus of claim 51, wherein the at least one processor sets the frequency reference based at least in part on a same band macro signal, in response to detecting that the different band macro signal and the GPS signal are not available.

53. The apparatus of claim 52, wherein the at least one processor sets a timing reference based at least in part on the different band macro signal, in response to the network comprising a synchronous network.

54. The apparatus of claim 53, wherein the at least one processor sets a timing reference based at least in part on the GPS signal, in response to detecting that the different band macro signal is not available.

55. The apparatus of claim 54, wherein the at least one processor sets a timing reference based at least in part on the same band macro signal, in response to detecting that the different band macro signal and the GPS signal are not available.

56. The apparatus of claim 55, wherein the at least one processor generates the timing reference based at least in part on strongest finger measurements of available PNs.

57. The apparatus of claim 50, wherein the network comprises an asynchronous network.

58. The apparatus of claim 52, wherein the at least one processor sets the frequency reference based at least in part on the same band macro signal by shutting down transmission for a shutdown period in order to receive the same band macro signal.

59. An apparatus operable in a wireless communication system, the apparatus synchronizing with a network and comprising:
at least one processor configured to: determine a signal strength of a Global Positioning System (GPS) signal; and set the frequency reference based at least in part on the GPS signal, in response to the GPS signal strength meeting a defined minimum strength; and
a memory coupled to the at least one processor for storing data.

60. The apparatus of claim 59, wherein the at least one processor sets the frequency reference based at least in part on a different band macro signal, in response to the GPS signal strength failing to meet the defined minimum strength.

61. The apparatus of claim 60, wherein the at least one processor sets the frequency reference based at least in part on the same band macro signal, in response to detecting that the different band macro signal and the GPS signal are not available.

62. The apparatus of claim 59, wherein the at least one processor sets a timing reference based at least in part on the GPS signal, in response to the network comprising a synchronous network.
